(19) United States
(12) Patent Application Publication
(10) Pub. No.: US 2024/0059907 A1
(43) Pub. Date: Feb. 22, 2024

(54) CORROSION INHIBITOR

(71) Applicant: Illinois Tool Works Inc., Glenview, IL (US)

(72) Inventor: Christopher Daniel Smith, Glenview, IL (US)

(73) Assignee: Illinois Tool Works Inc., Glenview, IL (US)

(21) Appl. No.: 18/269,587

(22) PCT Filed: Jan. 6, 2022
(86) PCT No.: PCT/US2022/011362

§ 371 Date: Jun. 26, 2023

Related U.S. Application Data
(60) Provisional application No. 63/134,451, filed on Jan. 6, 2021.

(51) Int. Cl. C09D 5/08; C09D 191/08; C09D 7/20; C09D 175/04; C09D 5/02

(52) U.S. Cl. CPC C09D 5/08; C09D 191/08; C09D 7/20; C09D 175/04; C09D 5/021

(57) ABSTRACT

A corrosion inhibiting composition includes a paraffinic oil present from 5 to 10 total weight percent, a sulfonated oil present from 15 to 25 total weight percent, a paraffin wax present from 1 to 10 total weight percent, a polymer present from 1 to 5 total weight percent, and at least one solvent present from 50 to 70 total weight percent. The corrosion inhibiting formulation does not include any aromatic solvents, and thus does not have the strong unpleasant odor common to alternatives.

### RELATED APPLICATIONS

This application claims priority benefit of U.S. Provisional Application Ser. No. 63/134,451 filed 6 Jan. 2021; the contents of which are hereby incorporated by reference.

### FIELD OF THE INVENTION

The present invention relates in general to corrosion inhibition and in particular to corrosion inhibition formulations that have better human health and environmental properties and are easier to apply and result in a smoother film than conventional solvent-based corrosion inhibition compositions.

### BACKGROUND OF THE INVENTION

Corrosion inhibitors per se are well known to those skilled in the art. They function to inhibit the extent to which a metal corrodes, thereby acting to extend the life of metal-containing industrial equipment, infrastructure, consumer goods and the like. Corrosion inhibitors may thus be useful across a wide range of industries.

Some corrosion inhibitors are provided as aerosol sprays, which provide for convenient application. Unfortunately, such formulations are typically flammable and include ingredients that have a strong unpleasant odor.

Additionally, some existing corrosion inhibitors are not compatible with non-metal materials. For example, some corrosion inhibitors tend to haze materials such as plexiglass. Given that materials such as plexiglass are often used as protective screens and windshields on metal-containing industrial equipment, infrastructure, and consumer goods to which corrosion inhibitors are often applied, it can be potentially dangerous for the corrosion inhibitors to haze such materials, making them difficult to see through.

Thus, there exists a need for a composition that provides corrosion inhibition of metal materials, which does not damage or degrade non-metal materials, that has an improved odor, and has better human health and environmental properties than conventional solvent-based corrosion inhibition compositions.

### SUMMARY OF THE INVENTION

A corrosion inhibiting composition includes a paraffinic oil present from 5 to 10 total weight percent, a sulfonated oil present from 15 to 25 total weight percent, a paraffin wax present from 1 to 10 total weight percent, a polymer present from 1 to 5 total weight percent, and at least one solvent present from 50 to 70 total weight percent. The corrosion inhibiting formulation does not include any aromatic solvents, and thus does not have the strong unpleasant odor common to alternatives.

### DETAILED DESCRIPTION OF THE PREFERRED EMBODIMENTS

The present invention has utility as a corrosion inhibitor that does not damage or degrade non-metal materials, has an improved odor, and has better human health and environmental properties than conventional solvent-based corrosion inhibition compositions.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

According to some inventive embodiments, an inventive corrosion inhibiting composition includes a paraffinic oil, a sulfonated oil, a paraffin wax, a polymer, and at least one solvent. According to some inventive embodiments, the inventive corrosion inhibiting formulation additionally includes at least one additive of a fragrance and/or a colorant. Notably, embodiments of the inventive corrosion inhibiting formulation do not include any aromatic solvents, and thus do not have a strong unpleasant odor. Accordingly, the inventive corrosion inhibiting formulations has improved human health and environmental properties than conventional solvent-based corrosion inhibition compositions. According to some inventive embodiments, the inventive formulation is provided as an aerosol. According to other inventive embodiments, the inventive formulation dries as a film after application to a surface. It is additionally noted that the inventive formulation does not haze non-metallic surfaces such as transparent acrylics or polycarbonates.

According to some inventive embodiments, the paraffinic oil is present from 5 to 10 total weight percent of the formulation, and in other inventive embodiments, the paraffinic oil is present from 7 to 8 total weight percent of the formulation. According to some inventive embodiments, the paraffinic oil is one that is produced using an all-hydroprocessing route which transforms the molecular structure of undesirable aromatics into highly desirable saturates. This produces a process oil with superior physical and chemical properties including lower aromatics, which result in superior color stability; lower volatility, which improves efficiency; and excellent compatibility with rubber polymers, which reduces processing headaches. Additionally, it is preferred that the paraffinic oil used has performance properties that surpass most conventional paraffinic process oils and approach or surpass many of the performance characteristics of technical white oils. These advantages include exceptionally low aromatic content, better color and UV stability than conventional paraffinic or naphthenic oils, almost complete resistance to degradation from ultraviolet discoloration, and lower volatility that results in fewer emissions.

According to embodiments, the sulfonated oil is present from 15 to 25 total weight percent of the formulation, and in some inventive embodiments, the sulfonated oil is present from 21 to 22 total weight percent of the formulation. According to some inventive embodiments, the sulfonated oil is a gelled calcium sulfonate, wax, oil and other ingredients in mineral spirits.

According to embodiments, the paraffin wax is present from 1 to 10 total weight percent of the formulation, and in some inventive embodiments, the paraffin wax is present from 4 to 5 total weight percent of the formulation. According to some inventive embodiments, the paraffin wax is a microcrystalline wax. Paraffin waxes come from the de-waxing of paraffin distillates. Paraffin waxes have relatively large, brittle crystals (Macrocrystalline) and generally have little affinity for oil. Microcrystalline waxes are derived from residium. These waxes have very minute crystals (micro-crystals) and are flexible, with a greater affinity for oil, which is held tightly in the crystalline lattice and do not migrate to the surface. According to some inventive embodiments the paraffin wax utilized has a melting point of 79.4° C. to 86.7° C. according to ASTM D-127.

According to some inventive embodiments, the polymer is present from 1 to 5 total weight percent of the formulation, and in some inventive embodiments, the polymer is present from 2 to 3 total weight percent of the formulation. According to some inventive embodiments, the polymer is a thermoset polymer. According to some inventive embodiments, the polymer is a polyurethane, and more particularly a HAP-free, fast air drying, soya oil modified polyurethane. Additional polymers operative herein illustratively include polyethylene powder, polyamides, tetrafluoroethylene polyester, and combinations thereof.

According to embodiments, the at least one solvent is present from 50 to 70 total weight percent of the formulation. According to some inventive embodiments, the at least one solvent includes an organic solvent that is present from 50 to 60 total weight percent of the formulation. According to some inventive embodiments, the organic solvent is mineral spirits, and in particular an odorless mineral spirits. Mineral spirits are a petroleum-derived clear liquid used as a common organic solvent in painting. A mixture of aliphatic, open-chain or alicyclic C7 to C12 hydrocarbons, white spirit is insoluble in water and is used as an extraction solvent, as a cleaning solvent, as a degreasing solvent and as a solvent in aerosols, paints, wood preservatives, lacquers, varnishes, and asphalt products. Mineral spirits have a characteristic unpleasant kerosene-like odor. Odorless mineral spirits are mineral spirits that have been further refined to remove the more toxic aromatic compounds, and are recommended for applications such as oil painting, where humans have close contact with the solvent. Odorless mineral spirits contain less of the highly volatile shorter hydrocarbons.

According to embodiments, the at least one solvent includes a glycol ether solvent that is present from 2 to 4 total weight percent of the formulation. According to some inventive embodiments, the glycol ether solvent is a slow-evaporating, hydrophobic glycol ether with excellent surface tension-lowering ability and coalescing properties. The glycol ether solvent has a near mid-range balance of hydrophobic and hydrophilic characteristics, and it offers significant water solubility. The glycol ether solvent has a high latex film quality owing in part to high polymer plasticizing efficiency, large molecular size and therefore greater polymer mobility contribution, strong partitioning to the polymer phase, and relatively slow evaporation rate. The glycol ether solvent also provides excellent surface tension lowering ability. According to some inventive embodiments, the glycol ether solvent is a colorless liquid with a mild odor and low volatility. The glycol ether solvent has low water solubility, good coupling and demonstrates good solvency for coating resins. According to some inventive embodiments the glycol ether solvent has a density of (pounds per gallon at 25° C.) 7.6, evaporation rate of (BuAc=100) 1.0, flash point of (SETA) ° C. (° F.) 101 (214), solubility by weight in water at 20° C. of 5%, solubility parameter of (Total Hansen) 9.4, surface tension of (Dynes/cm) @ 25° C. (77° F.) 29, refractive index @ 25° C. (77° F.) of 42, viscosity (centistokes) @ 25° C. (77° F.) of 4.8, and vapor Pressure@ 25° C. (77° F.) (mmHg) of 0.03. According to some inventive embodiments the glycol ether is hexyl carbitol, which is a glycol ether with a longer chain which reduces volatility, odor and evaporation. The glycol ethers help disperse the wax in the mineral spirits. The hexyl version does a better job than the propyl versions. According to embodiments, the solvent includes 2-propanol, 1-(1-methyl-2-propoxyethoxy)-glycol, and combinations thereof.

According to some inventive embodiments, the at least one solvent includes a propylene glycol butyl ether solvent that is present from 5 to 6 total weight percent of the formulation. According to some inventive embodiments, the propylene glycol butyl ether solvent is a fast-evaporating, hydrophobic glycol ether with high solvency and excellent coupling abilities. It is partly water soluble and miscible with most organic solvents. Preferably, the propylene glycol butyl ether solvent has a low toxicity and pleasant smell. Additional characteristics of the propylene glycol butyl ether solvent include excellent solubility and good oil solubility, excellent surface and coupling properties, and low viscosity, low odor, and low toxicity. According to some inventive embodiments, the solvent includes propylene glycol monopropyl ether.

As noted above, embodiments of the inventive corrosion inhibiting formulation additionally include at least one additive, which according to embodiments is a fragrance to provide a pleasing aroma and/or a pigment to provide color. According to some inventive embodiments, the at least one additive is present from 0 to 5 total weight percent of the formulation. According to some inventive embodiments, the at least one additive includes a fragrance present from 0.1 to 1 total weight percent of the formulation, which may be a sweet cherry fragrance. According to some inventive embodiments, the at least one additive includes a pigment present from 0.01 to 0.05 total weight percent of the formulation. Pigments operative herein illustratively include oxides, sulfides, selenides, sulfates of various metals such as iron, cobalt, tin, manganese, and combinations thereof. It is appreciated that magnetic particles or other inert fillers can be present and considered as a coloring pigment additive.

An inventive composition is readily packaged in an aerosol container with a propellant. In order to achieve the reduction in flammability associated with present invention relative to the prior art, the propellant is selected to be a majority by propellant weight of a non-hydrocarbon propellant. In still other embodiments of the present invention, the propellant is devoid of hydrocarbons and halocarbons. Preferred propellants according to the present invention include carbon dioxide, nitrogen, trans 1,3,3,3-tetrafluoropropene (HFO 1234ze), or a combination thereof. Typical loading of a propellant are from 1 to 5 percent if carbon dioxide or nitrogen are present, and from 20-40 percent if trans 1,3,3,3-tetrafluoropropene (HFO 1234ze) is present by weight of the chlorinated ethylene and the at least one halocarbon. While propellants are operative in the present invention, as noted above, when are present, the propellant is present as a minority constituent. Exemplary of such propellants, are 1,1,1,2-tetrafluoroethane, dimethyl ether, and isobutene.

An aerosol package containing an inventive solvent composition includes an aerosol container having a volume and an aperture. The container is formed from a material that is compatible with the inventive solvent composition and includes a container wall or at least liner contacting the volume in which the solvent resides that is illustratively formed from metals such as tin plated steel, aluminum; glass; or polymer coated steel. A spray nozzle is provided to selectively seal the aperture. In inventive embodiments inclusive of a propellant, a one piece valve is preassembled with the valve cup, dip tube, actuator, can as unitary assembly, and prior to pressure-filling.

In a particular inventive embodiment, the propellant is carbon dioxide present in an amount of from 1 to 5 weight percent of the inventive formulation. Without intending to be bound to a particular theory of operation, it is believed that carbon dioxide in the spray environment by locally and transiently displacing some atmospheric oxygen reduces the likelihood of spontaneous ignition, especially in confined spaces thereby making the inventive composition suitable for usage in such settings.

Embodiments of the inventive corrosion inhibitor provide the benefits of not damaging or degrading non-metal materials, having an improved odor, and having better human health and environmental properties than conventional solvent-based corrosion inhibition compositions. These desirable properties are in part from avoiding aromatic solvents in the formulation and using lower chain glycol ethers. Surprisingly, embodiments of the inventive corrosion inhibitor additionally provide unexpected desirable properties of easier sprayability, forming a more even and smoother film upon application, and providing better wash off capabilities as compared to conventional corrosion inhibition compositions. That is, in addition to having less of an odor, embodiments of the inventive corrosion inhibitor also have improved flowability of the sprayed film making a better film and the ability to wash off the product. It has been surprisingly found that the glycol ethers are surfactants and therefore help in the wash off, the two shorter chain materials currently used are volatile, so they evaporate away and are not present when a wash off operation is run, and the hexyl version is not volatile, so acts as a surfactant in the film, aiding the removal.

A process of protecting an iron containing metal from corrosion involves the exposure of the metal to an inventive formulation. Through the monitoring of corrosion of the metal over time, the corrosion protection of the metal is assured. The inventive formulation being reapplied when the monitoring indicates that the corrosion of the metal exceeds a preselected threshold.

It is appreciated that upon preparing a solution, still further amounts of the aforementioned additives are added to the solution. Co-solvents miscible with water are also provided in some inventive embodiments. Co-solvents operative herein illustratively include amine solvents such pyridine, piperidine, collidine, ethylenediamine, quinolone, diethylenetriamine, monoethanolamine, triethanolamine, diglycolamine, diisopropanolamine, 2-amino-2-methyl-1-propanol, and combinations thereof.

According to embodiments, the inventive corrosion inhibiting formulation is prepared by pre-heating the sulfonated oil and mixing it with the paraffinic oil. Next, the mixture of the sulfonated oil and the paraffinic oil is heated to a temperature of at least 175° F. Next, the paraffin wax is combined with the mixture of the sulfonated oil and the paraffinic oil and allowed to melt. Next, at least half of the solvent is added to the mixture of sulfonated oil, paraffinic oil, and paraffin wax. According to embodiments, different types of solvents are added separately. For example, a glycol ether solvent is added to the mixture of sulfonated oil, paraffinic oil, and paraffin wax and mixed for at least 30 minutes, followed by half of the mineral spirits being heated and added to the mixture, followed by the propylene glycol butyl ether solvent being added to the mixture. Next, the mixture is allowed to cool to at least 100° F. while it is continuously mixed. Next, the polyurethane and any additives are added to the mixture, which is mixed for at least 5 hours. Finally, the remainder of the solvent is gradually added to the mixture. For example, the second half of mineral spirits is added to the mixture of ingredients and mixed for at least 30 minutes.

### EXAMPLES

The present invention is further detailed with respect to the following non-limiting examples.

### Example 1

As shown in Table I, 1558 pounds of sulfonated oil are pre-heated and 558 pounds of paraffinic oil are pumped into a vat. The heated sulfonated oil is added to the paraffinic oil in the vat and are mixed together. The contents of the vat are pumped through a heat exchanger to heat the contents to a temperature of at least 175° F. Next, 313 pounds of paraffin wax are sprinkled into the vat and melted and combined with the mixture of the sulfonated oil and the paraffinic oil. Next, 210 pounds of a glycol ether solvent are added to the mixture, and the mixture is mixed for at least 30 minutes. Next, 1961 pounds of mineral spirits are run through a heat exchanger to warm up the mineral spirits. The warmed 1961 pounds of mineral spirits are then pumped into the vat with the mixed ingredients. Next, 391 pounds of propylene glycol butyl ether solvent are added to the vat mixture. The cold side of the heat exchanger begins to cool the vat mixture while the mixture is continuously mixed at an increased speed. When the vat mixture reaches a temperature of 100° F., the heat exchanger is turned off and 148 pounds of polyurethane, 33 pounds of a fragrance, and 1.4 pounds of a dye are added to the vat and mixed overnight. Next, 1961 pounds of mineral spirits are gradually added to the vat mixture and mixed for at least an additional 30 minutes.

TABLE I
Example 1

| Ingredient | Amount (lbs.) | Total Weight % |
|---|---|---|
| Paraffinic oil | 558 | 7.821 |
| Sulfonated oil | 1558 | 21.838 |
| Paraffin wax | 313 | 4.387 |
| Solvent | 210 | 2.943 |
| Solvent | 3922 | 54.973 |
| Solvent | 391 | 5.480 |
| Polyurethane | 148 | 2.074 |
| Additive | 33 | 0.463 |
| Additive | 1.4 | 0.020 |
| Total | 7134.4 | |

### Example 2

As shown in Table II, 1640 pounds of sulfonated oil are pre-heated and 587 pounds of paraffinic oil are pumped into a vat. The heated sulfonated oil is added to the paraffinic oil in the vat and are mixed together. The contents of the vat are pumped through a heat exchanger to heat the contents to a temperature of at least 175° F. Next, 330 pounds of paraffin wax are sprinkled into the vat and melted and combined with the mixture of the sulfonated oil and the paraffinic oil. Next, 222 pounds of a glycol ether solvent are added to the mixture, and the mixture is mixed for at least 30 minutes. Next, 2065 pounds of mineral spirits are run through a heat exchanger to warm up the mineral spirits. The warmed 2065 pounds of mineral spirits are then pumped into the vat with the mixed ingredients. Next, 400 pounds of propylene glycol butyl ether solvent are added to the vat mixture. The cold side of the heat exchanger begins to cool the vat mixture while the mixture is continuously mixed at an increased speed. When the vat mixture reaches a temperature of 100° F., the heat exchanger is turned off and 156 pounds of polyurethane, 34.5 pounds of a fragrance, and 1.5 pounds of a dye are added to the vat and mixed overnight. Next, 2065 pounds of mineral spirits are gradually added to the vat mixture and mixed for at least an additional 30 minutes.

TABLE II
Example 2

| Ingredient | Amount (lbs.) | Total Weight % |
|---|---|---|
| Paraffinic oil | 587 | 7.826 |
| Sulfonated oil | 1640 | 21.864 |
| Paraffin wax | 330 | 4.399 |
| Solvent | 222 | 2.960 |
| Solvent | 4130 | 55.059 |
| Solvent | 400 | 5.333 |
| Polyurethane | 156 | 2.080 |
| Additive | 34.5 | 0.460 |
| Additive | 1.5 | 0.020 |
| Total | 7501 | |

### Example 3

As shown in Table III, 1722 pounds of sulfonated oil are pre-heated and 616 pounds of paraffinic oil are pumped into a vat. The heated sulfonated oil is added to the paraffinic oil in the vat and are mixed together. The contents of the vat are pumped through a heat exchanger to heat the contents to a temperature of at least 175° F. Next, 347 pounds of paraffin wax are sprinkled into the vat and melted and combined with the mixture of the sulfonated oil and the paraffinic oil. Next, 233 pounds of a glycol ether solvent are added to the mixture, and the mixture is mixed for at least 30 minutes. Next, 2168 pounds of mineral spirits are run through a heat exchanger to warm up the mineral spirits. The warmed 2168 pounds of mineral spirits are then pumped into the vat with the mixed ingredients. Next, 433 pounds of propylene glycol butyl ether solvent are added to the vat mixture. The cold side of the heat exchanger begins to cool the vat mixture while the mixture is continuously mixed at an increased speed. When the vat mixture reaches a temperature of 100° F., the heat exchanger is turned off and 164 pounds of polyurethane, 36 pounds of a fragrance, and 1.6 pounds of a dye are added to the vat and mixed overnight. Next, 2168 pounds of mineral spirits are gradually added to the vat mixture and mixed for at least an additional 30 minutes.

TABLE III
Example 3

| Ingredient | Amount (lbs.) | Total Weight % |
|---|---|---|
| Paraffinic oil | 616 | 7.809 |
| Sulfonated oil | 1722 | 21.829 |
| Paraffin wax | 347 | 4.399 |
| Solvent | 233 | 2.954 |
| Solvent | 4336 | 54.965 |
| Solvent | 433 | 5.489 |
| Polyurethane | 164 | 2.079 |
| Additive | 36 | 0.456 |
| Additive | 1.6 | 0.020 |
| Total | 7888.6 | |

The foregoing description is illustrative of particular embodiments of the invention but is not meant to be a limitation upon the practice thereof. The following claims, including all equivalents thereof, are intended to define the scope of the invention.

1. A corrosion inhibiting composition comprising:
a paraffinic oil present from 5 to 10 total weight percent;
a sulfonated oil present from 15 to 25 total weight percent;
a paraffin wax present from 1 to 10 total weight percent;
a polymer present from 1 to 5 total weight percent; and
at least one solvent present from 50 to 70 total weight percent.

2. The corrosion inhibiting composition of claim 1 wherein the paraffinic oil is present from 7 to 8 total weight percent.

3. The corrosion inhibiting composition of claim 1 wherein the sulfonated oil is present from 21 to 22 total weight percent.

4. The corrosion inhibiting composition of claim 1 wherein the paraffin wax is present from 4 to 5 total weight percent.

5. The corrosion inhibiting composition of claim 1 wherein the polymer is present from 2 to 3 total weight percent.

6. The corrosion inhibiting composition of claim 1 wherein the paraffin wax is a microcrystalline wax.

7. The corrosion inhibiting composition of claim 1 wherein the polymer is a thermoset polymer.

8. The corrosion inhibiting composition of claim 1 wherein the polymer is a polyurethane.

9. The corrosion inhibiting composition of claim 1 wherein the composition dries as a film after application.

10. The corrosion inhibiting composition of claim 1 wherein the composition is an aerosol.

11. The corrosion inhibiting composition of claim 1 wherein the at least one solvent includes an organic solvent.

12. The corrosion inhibiting composition of a claim 11 wherein the organic solvent is present from 50 to 60 total weight percent.

13. The corrosion inhibiting composition of claim 11 wherein the organic solvent is mineral spirits.

14. The corrosion inhibiting composition of claim 1 wherein the at least one solvent includes a glycol ether solvent.

15. The corrosion inhibiting composition of claim 14 wherein the glycol ether solvent is present from 2 to 4 total weight percent.

16. The corrosion inhibiting composition of claim 1 wherein the at least one solvent includes a propylene glycol butyl ether solvent.

17. The corrosion inhibiting composition of claim 16 wherein the propylene glycol butyl ether solvent is present from 5 to 6 total weight percent.

18. The corrosion inhibiting composition of claim 1 further comprising at least one additive present from 0 to 5 total weight percent.

19. The corrosion inhibiting composition of claim 18 wherein the at least one additive includes a fragrance present from 0.1 to 1 total weight percent.

20. The corrosion inhibiting composition of claim 18 wherein the at least one additive includes a dye present from 0.01 to 0.05 total weight percent.
